(19) United States
(12) Patent Application Publication
(10) Pub. No.: US 2010/0288515 A1
(43) Pub. Date: Nov. 18, 2010

(54) ALL-IN-ONE PACKING, PAD AND SHOE FOR HOOF PROTECTION

(75) Inventor: Frank Rovelli, Oxnard, CA (US)

Correspondence Address: KOPPEL, PATRICK, HEYBL & DAWSON, 2815 Townsgate Road, SUITE 215, Westlake Village, CA, 91361-5827, US

(73) Assignee: Vettee, Inc., Oxnard, CA (US)

(21) Appl. No.: 12/374,301

(22) PCT Filed: Oct. 21, 2008
(86) PCT No.: PCT/US08/80661

§ 371 Date: Mar. 11, 2010

Related U.S. Application Data
(60) Provisional application No. 61/022,454, filed on Jan. 21, 2008.

(51) Int. Cl. A01L 3/02

(52) U.S. Cl. 168/4

(57) ABSTRACT

An all-in-one packing, pad and shoe substitute for barefoot horse hoof protection, comprising a plug of resin in fixed relation with the hoof bottom wall and a vertical extent of the interior hoof side wall dimensioned sufficient for ground contact adjacent the hoof wall face, the hoof side wall face being free of an added conventional external horseshoe.

### REFERENCE TO RELATED APPLICATIONS

This application claims the benefit under 35 U.S.C. §§120 and 365(c) as a continuation-in-part of International Application No. PCT/US08/80661, filed Oct. 21, 2008, which designates the United States of America and claims the benefit of U.S. Provisional Application Ser. No. 61/022,454, filed Jan. 21, 2008. This application also claims the benefit of U.S. Provisional Application Ser. No. 61/109,164, filed Oct. 28, 2008. The disclosures of these applications are expressly incorporated into this application.

### BACKGROUND OF THE INVENTION

1. Technical Field

This invention relates to hoof protection and more particularly to protection of the hoofs of so-called barefoot horses. Barefoot horses are those that are not given horseshoes on their hoofs partly out of concern for the health of the horses. Normal horse shoeing involves nailing or gluing shoes, of metal or plastic, onto the bottom of each hoof; these shoes are replaced periodically as part of the normal maintenance of hoof heath. See U.S. Pat. No. 6,231,972 for a description of a resinous shoe-like coating formed in-situ on the hoof ground-contacting portions in lieu of a conventional metal shoe. See U.S. Pat. No. 7,174,858 for a description of an overshoe or boot proposed to temporarily protect the hoof as during a recreational ride. While boots can be put on by the rider/owner as needed and no farrier is required, they are costly to acquire and awkward to put on and uncertain of being kept on.

Damage to the hoof from shoe fastening or from ill-fitted or broken shoes suggests that there must be a better way than the way that has been used for millennia. The present invention provides a better way, one that enables the horse to be barefoot in the sense of being without conventional or even updated versions of external shoeing and yet protected from environmental problems.

2. Related Art

In typical horse care, in the course of renewing horseshoes, webs of leather, plastic or rubber, called pads, are attached to the hoof edge walls beneath the horse shoe, and sized to extend across the hoof sole and cover the frog and sole containing recessed portion of the hoof, e.g. inserted between the horseshoe and the hoof side wall to protect these sensitive areas of the hoof. Moisture and debris sometimes work their way into the open volume recess defined broadly by the hoof solar or bottom wall (comprising the hoof sole and frog) and the hoof side wall, causing discomfort in or harm to the animal. Efforts to fill the recess have involved adding packing including resins to the sole that can be covered with the web. Resinous packings that adhere to the hoof bottom and side wall have been proposed. See e.g. U.S. Pat. No. 6,009,952. Thus, shoes, packing and pads are known to be used to protect the hoof. The complexity of applying one or all of these expedients to a horse on a recurring basis and achieving adhesion at the side wall edge has been problematic and added expense to the keeping of horses.

### SUMMARY OF THE INVENTION

It is an object of the invention accordingly to provide products and methods for improving the health of hoofed animals particularly barefoot horses by combining the packing, pad and ‘shoe” into a single application that can be effected quickly and at lower expense by a farrier, a veterinarian, or in many cases by the owner. It is a further object to provide a method of both packing with a pad and “shoeing” a horse in a horseshoe-free manner. A further object is to form fixed hoof recess-filling plugs from reactive resin mixtures filled into the hoof recess from a dual cartridge dispenser containing separate, reactive precursor components of the hoof packing and plug-shoe-forming material. Further, the invention objects include providing a hoof pad and packing and shoeless shoe forming method and product therefor that flows easily and readily into the hoof recess and the interstices thereof and remains there even with the hoof face (area of wall normally in contact with the ground) disposed at about 90 degrees to the ground (turning the hoof recess fully upward parallel with the ground is recommended but is not necessary). The product sets up nearly immediately to a firm, somewhat resilient plug that adheres to and yet moves with the hoof wall, frog and sole portions as they move under the forces of ground impacts. The plug adhesion, particularly at the sidewalls where previous packing products tend to lose adhesion, or other fixing expedient such as added adhesive or fasteners, militates against loss of the plug from the recess even over weeks of use, and prevents incursions of environmental hazards such as trail debris and moisture between the plug and the hoof portions.

These and other objects of the invention to become apparent hereinafter are realized in accordance with the invention in a all-in-one packing, pad and shoe for barefoot horse hoof protection, comprising a plug of synthetic organic resin dimensioned for ground contact from within the hoof.

In this and like embodiments, typically, the hoof is maintained free of an external horseshoe, the synthetic organic resin plug is formed in situ, and the resin is a urethane resin formed from reactive components jointly introduced within the hoof.

In a further embodiment, the invention provides an all-in-one packing, pad and shoe for full barefoot horse hoof protection, comprising a plug of solid, void-free synthetic organic resin formed in situ and in adherent contact within the hoof against debris and moisture incursions and dimensioned for ground contact adjacent the hoof side wall face, the hoof being free of an external horse shoe. Again, typically, the resin plug is formed in situ from reactive components jointly introduced within the hoof, the synthetic organic resin plug reactive components comprise urethane reactants reacting to a resin having a non-flowing condition in less than about 15-20 seconds, more or less, e.g. 5 to 40 seconds, and having a resistance to deterioration requiring replacement for at least about 15-20 days, or more.

Additionally, the invention provides an all-in-one packing, pad and shoe for barefoot horse hoof protection, comprising a plug of synthetic organic resin in fixed relation with the hoof bottom wall and interior side wall sufficient for ground contact adjacent the hoof wall face, the hoof side wall face being free of an external horseshoe.

In its first method aspects, the invention provides a method for extended protection of a shoe-less hoof having a hoof side wall and bottom wall forming an interior recess from environmental hazards with a synthetic organic resin plug, including cleaning the recess, and adding the resin plug into the recess in fixed relation and dimensioned sufficient for ground contact.

In this and like method embodiments, typically, there is further included maintaining the hoof external horse shoe free, using a plug comprised of urethane resin, and smoothing the just added resin with a nonadherent wipe to a desired contour.

In a further first method aspect the invention provides a method for extended protection of a shoe-less hoof having a hoof side wall and bottom wall forming an interior recess from environmental hazards with a resin plug, including cleaning the recess and adding to the recess to form a plug of resin in fixed relation and dimensioned sufficient for ground contact in the absence of a shoe a resin reactant mixture that flows freely into the recess while simultaneously reacting the mixture at a rate precluding spillage of said resin from the recess while leaving the hoof free of an external shoe.

In this and like method embodiments, typically there is further included smoothing the exposed portion of the plug resin reaction mixture with a resin-nonadherent plastic film.

The invention further provides the combination of an external horseshoe-free horse hoof and a plug as described above, and the combination of a shoeless horse hoof having a hoof side wall and a bottom wall forming an interior recess and a fixed resin plug in the recess as described above.

In a second embodiment the invention provides an all-in-one packing, pad and shoe for barefoot horse hoof protection, comprising a hoof interior-adherent plug of resin dimensioned for ground contact.

In this second embodiment and like embodiments of the invention, typically, the hoof is free of an external horseshoe, the resin plug is formed in situ, and the resin is a urethane resin formed from reactive components jointly introduced into the hoof.

In a further aspect of the second embodiment, the invention provides an all-in-one packing, pad and shoe for full barefoot horse hoof protection, comprising a plug of solid, void-free resin formed in situ and in adherent contact with the hoof interior against debris and moisture incursions and dimensioned for ground contact adjacent the hoof side wall face, the hoof being free of an external horse shoe. The resin plug is formed in situ from reactive components jointly introduced into said hoof, the resin plug reactive components comprising urethane reactants reacting to a resin having a non-flowing condition in less than about 15-20 seconds, more or less e.g. from about 5 to about 40 or more seconds, that is the resin plug reactive urethane components comprise reactants solidifying sufficiently rapidly as to flow into but not out of a horse hoof whose side wall face is held normal to the ground; the resultant plug having a resistance to deterioration requiring replacement for at least about 15-20 days or greater.

In its method aspects the second embodiment of the invention provides a method for extended protection of a shoe-less hoof having a hoof side wall and bottom wall forming an interior recess from environmental hazards with a resin plug, including cleaning the recess, and adherently adding the resin plug into the recess, the plug being dimensioned sufficient for ground contact. In this and like embodiments, typically, there is further included maintaining the hoof external horse shoe free, using a plug comprised of urethane resin, and smoothing the just added resin with a nonadherent wipe to a desired contour.

In a further aspect of the second embodiment method, there is provided a method for extended protection of a shoe-less hoof having a hoof side wall and bottom wall forming an interior recess from environmental hazards with a resin plug, including cleaning the recess and adding to the recess to form a plug of resin dimensioned sufficient for ground contact in the absence of a shoe a resin reactant mixture that flows freely into the recess in adhering relation while simultaneously reacting said mixture at a rate precluding spillage of the added resin from the recess while leaving the hoof side wall face free of resin and free of external shoe material. In this aspect there is further included disposing the hoof side wall face to receive said free flowing resin, and smoothing the exposed portion of the plug resin reaction mixture with a resin-nonadherent plastic film.

The invention in this second embodiment further provides the combination of an external horseshoe-free horse hoof and a plug as described and the combination of a shoeless horse hoof having a hoof side wall and a bottom wall forming an interior recess and an adherent resin plug in the recess also as described.

In a third embodiment, the invention provides a method for extended protection of a shoe-less hoof having a hoof side wall and bottom wall forming an interior recess from environmental hazards with a resin plug, including cleaning the recess and adding the resin plug into the recess in fixed relation and dimensioned sufficient for ground contact. The resin plug can be adherently added into the recess by filling the recess with the plug, preformed or formed in situ, to substantially the full vertical extent of the hoof side wall and sufficient for ground contact, and adhering the plug to the hoof bottom wall and an extent of the hoof side wall and freely of an external shoe beyond the plug.

In this and like embodiments, typically, the method further includes using a plug comprised of urethane resin formed in situ and smoothing the just dispensed resin with a nonadherent wipe to a desired contour.

In a further aspect of the third embodiment, the invention provides a method for extended protection of a shoe-less hoof having a hoof side wall and bottom wall forming an interior recess from environmental hazards with a resin plug, including cleaning the recess and filling the recess to substantially the full vertical extent of the hoof side wall sufficient for ground contact in the absence of a shoe with a resin reactant mixture that flows freely into the recess in adhering relation while simultaneously reacting the mixture at a rate precluding spillage of the resin from the recess.

In this and like embodiments, typically, the invention method includes disposing the hoof to receive the free flowing resin, and smoothing the exposed portion of the plug with a resin-nonadherent film such as a plastic film.

In a still further aspect, the invention includes providing the combination of a horseshoe-free horse hoof and a plug as described above. In a yet further aspect the invention provides the combination of a shoeless horse hoof having a hoof side wall and a bottom wall forming an interior recess and a resin plug adhered to and filling the recess after being formed outside of or in situ in the recess.

The invention further provides an all-in-one packing, pad and shoe substitute for barefoot horse hoof protection, comprising a plug of resin in adherent contact with the hoof bottom wall and a vertical extent of the interior hoof side wall sufficient for ground contact adjacent the hoof wall face, the hoof side wall face being free of an external horseshoe.

In this and like embodiments, typically, the resin plug is formed in situ, and the resin is a urethane resin formed from reactive components typically jointly introduced into the hoof, e.g. in admixed relation.

In a further embodiment the invention provides an all-in-one packing, pad and shoe substitute for full barefoot horse hoof protection, comprising a plug of solid, void-free resin formed in situ and in adherent contact with the hoof bottom wall and sufficient vertical extent of the interior hoof side wall against debris and moisture incursions and sized for ground contact adjacent the hoof side wall face, the hoof being free of an external horse shoe.

In this and like embodiments, typically, the resin plug is formed in situ, the resin is formed from reactive components jointly introduced into the hoof, the resin plug reactive components comprise urethane reactants reacting to a resin having a non-flowing condition in less than about 15-20 seconds and having a resistance to deterioration requiring replacement for at least about 15-20 days, a typical period between hoof treatments, and the resin plug reactive urethane components comprise reactants solidifying sufficiently rapidly as to flow into but not out of a horse hoof whose side wall face is held normal to the ground.

### BRIEF DESCRIPTION OF THE DRAWINGS

The invention will be further described in conjunction with the accompanying drawings in which:

FIG. 1 is a hoof side wall face view of the invention all-in-one hoof protection in place on a hoof;

FIG. 2A is a view taken on line 2A-2A in FIG. 1; and

FIG. 2B is a view like FIG. 2A-2A with the hoof being inverted to its normal position with the all-in-one packing, pad and shoe in place.

### DETAILED DESCRIPTION

Horse hoofs are conventionally shod by nailing a horseshoe to the horny side wall face exteriorly forming the outer portion of the hoof. Within the side wall and surrounded substantially by the interior part of the hoof side wall are the sole of the hoof and the sensitive frog portion of the hoof, i.e. portions comprising the bottom aspect of the hoof, sometimes referred to as the solar, and generally referred to herein jointly as the hoof bottom wall. These portions of the hoof are not protected from damage from contact with moisture or other forms of debris and harmful objects unless one adds a pad, a web across the hoof sole, usually supported by the horseshoe or horseshoe nails to protect the sole of the hoof. Debris can enter the open recess defined by the hoof bottom wall and surrounding side wall, even under the web unless the recess is filled with a suitable material called packing. Suitable materials will fill all spaces in the volume and prevent voids and interstices from occurring. In the past, foam resins have been employed, but they do not hold up against the stresses imposed in use and allow incursions of debris, moisture and contamination. Other materials are stiff and difficult to work with and like the foam systems do not adhere to the hoof bottom wall and thus allow, especially after wearing for a time, the incursion of debris which is uncomfortable and even harmful to the horse. Other materials initially adherent to the hoof sole and frog are disclosed in U.S. Pat. No. 6,009,952 and described to be placed under a pad or not but to extend to less than the full vertical height of the hoof side wall whereby they form a packing, but not a pad substitute and not a shoe substitute, and do not adequately adhere to the side wall full extent such that packing breakdown can occur over a shorter period than is useful for a shoe product as opposed to a packing product.

The present invention provides a solid, typically noncellular and void-free plug to not only fill the recess as a packing, but due to the dimensions of the plug relative to the hoof recess to extend in persistent adhering relation a selected, e.g. full, vertical height of the side wall. The plug thus extends through the recess up to (and beyond in a proper case) the hoof side wall face (i.e. the part that contacts the ground in the absence of a shoe). The plug while acting as a packing also takes the place of a pad and being dimensioned as described functions as a shoe substitute. Being fixed e.g. adhered to the hoof bottom wall the plug acts against incursive attacks from debris and moisture for weeks of use. The preferred urethane resins herein are broadly disclosed in U.S. Pat. No. 4,869,400, are thixotropic, and are known to be injectable using dual cartridge dispensers which direct reactive components of low viscosity through a static mixer into the hoof recess where their initially low viscosity enables flow throughout the recess and into the nooks, crannies, interstices and voids of the recess. The resin mixture thixotropes, cures, and adheres to the walls, void-free and more resilient than the surrounding hoof to cushion the steps of the horse while protecting from debris incursions.

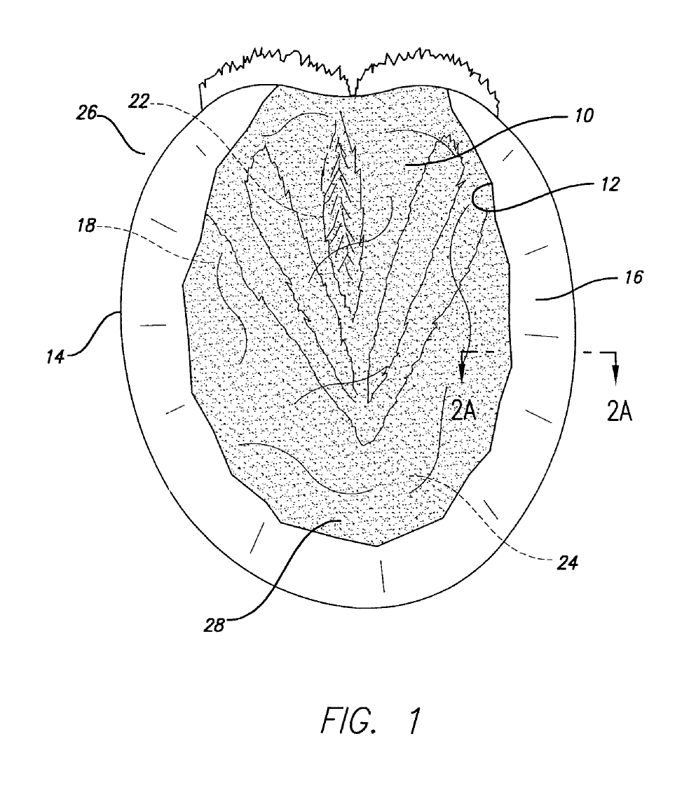

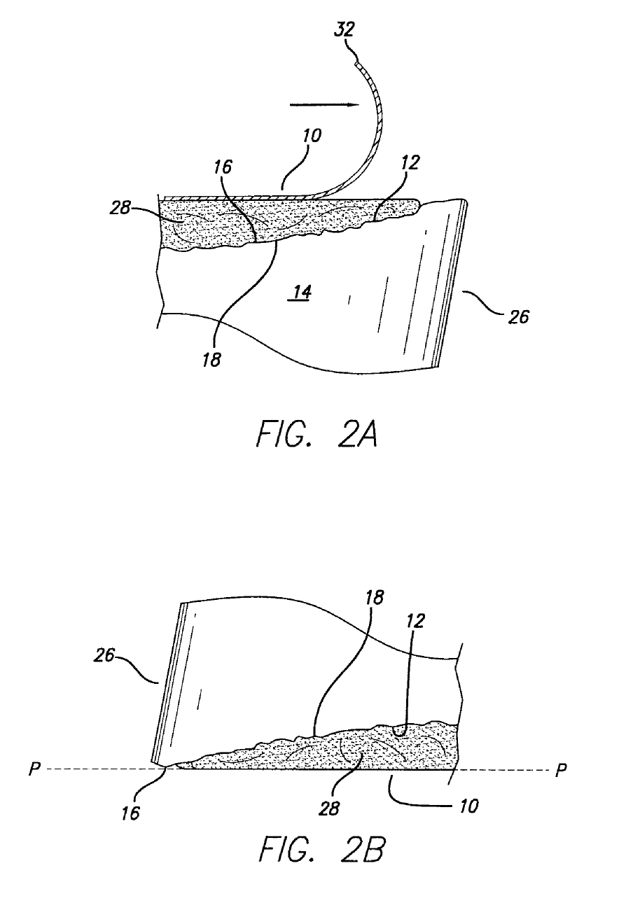

With reference to FIGS. 1, 2A and 2B, the all-in-one shoeless hoof protection plug is shown at 10 within recess 12 of hoof 26 formed by hoof side wall 14. No shoe nails are used, no webs are used and there is no horseshoe or horseshoe-like covering of the hoof side wall face 16. The hoof recess 12 is further defined by the hoof bottom wall 18, comprising the hoof sole portion 22 and the hoof frog portion 24, all in hidden lines to show their location under plug 10.

In the invention method, the recess 12 is thoroughly cleaned of debris, old packing material and other extraneous material, ensured to be quite dry, and then filled with plug 10 in fixed relation using an injectable, e.g. liquid resin having the compositions described herein or a preform thereof, dimensioned for ground contact from within the hoof 26. Because of the thixotropy and rapid cure of the resin, e.g. in from 15 to 20 seconds, 5-40 seconds or other cure time selected, the resin reactants can be injected into the recess 12 held sideways, that is as the hoof side wall face 16 is disposed normal to the ground, i.e. at substantially 90 degrees to the ground, with no loss of resin, and with no need to support the resin in place pending cure although holding the hoof flat with the frog portion turned upward is to be preferred. The plug 10 is preferably formed in situ and thus adhered, or adhered with an additional adhesive such as a urethane resin, or mechanical fasteners in a suitable case to be hoof-interior, i.e. hoof recess 12 adherent and fixed in place, to ensure full contact with substantially all the voids, crevices and interstices of the hoof sole portion 22 including areas surrounding and covering the frog portion 24 of the hoof, and to filling the recess 12 so that incursions of debris including moisture into the recess 12 are blocked.

Thus, in one embodiment the invention method for extended protection of a shoe-less hoof 26 having a hoof side wall 14 and bottom wall 18 forming an interior recess 12 from environmental hazards with a resin plug 10, includes cleaning and filling the recess to substantially the full vertical extent of the hoof side wall sufficient for ground contact with the resin plug 10 suitably comprised of urethane resin and adhered to the hoof bottom wall and hoof side wall and freely of an external shoe beyond the plug.

In a further method embodiment the invention method for extended protection of a shoe-less hoof 26 having a hoof side wall 14 and bottom wall 18 forming an interior recess 12 from environmental hazards with a resin plug 10, includes cleaning and filling the recess to substantially the full vertical extent of the hoof side wall sufficient for ground contact in the absence of a shoe with a resin reactant mixture that flows freely into the recess in adhering relation while simultaneously reacting the mixture at a rate precluding spillage of the resin from the recess. This and like invention methods include disposing the hoof side wall face 16 to receive the resin, and smoothing the exposed portion of the plug mass 28 with a plastic film 32 that is not adherent to the uncured or cured resin to contour to a desired shape conducive to the horse's comfort.

The invention thus provides the combination of a horseshoe-free horse hoof 26 and a plug 10 and the further combination of a shoeless horse hoof 26 having a hoof side wall 14 and a bottom wall 18 forming an interior recess 12 and a resin plug 10 adhered to and filling the recess, e.g. to the plane P-P of the hoof wall face, after being formed outside of or in situ in the recess.

A further aspect of the invention is the provision of an all-in-one packing, pad and shoe substitute for barefoot horse hoof protection, comprising a plug 10 of resin in adherent contact with the hoof bottom wall 18 and a vertical extent of the interior hoof side wall 14 sufficient for ground contact adjacent the hoof wall face 16, the hoof side wall face being free of an external horseshoe. The resin plug 10 is preferably formed in situ employing preferably a urethane resin formed from reactive components typically jointly introduced into the hoof recess 12 in admixed relation.

Preferably, the all-in-one packing, pad and shoe for full barefoot horse hoof protection comprises a plug 10 of solid, void-free resin formed in situ and in adherent contact with the hoof bottom wall 18 and sufficient vertical extent of the interior hoof side wall 14 against debris and moisture incursions and sized for ground contact adjacent the hoof side wall face 16, the hoof 26 being free of an external horse shoe. Again, the resin plug 10 is formed in situ, the resin is formed from reactive components jointly introduced into the hoof, the resin plug reactive components comprise urethane reactants reacting to a resin having a non-flowing condition in less than about 15-20 seconds and having a resistance to deterioration through loss of sidewall or other adhesion or otherwise requiring replacement for at least about 15-20 days, and the resin plug reactive urethane components comprise reactants solidifying sufficiently rapidly as to flow, preferably, into but not out of a horse hoof 26 whose side wall face 16 is held normal to the ground.

Resin reactants, are typically synthetic organic resins, such as those taught in the '400 patent cited herein, comprise, e.g. a Side A isocyanate containing reactant and a Side B polyol containing reactant to produce a urethane resin, and are preferably separately packaged in piston and cylinder dual cartridges of the there illustrated, well-known dispenser. The two reagent Sides A and B are expressed from their respective cartridges with hand pressure on a piston pair and upon such expression are intensively mixed in cartridge-attached static mix tip and injected into recess 12.

A typical resin formulation (parts by weight per 100 parts) includes:

Resin reactants, such as those taught in the '400 patent cited herein, comprise, e.g. a Side A isocyanate containing reactant and a Side B polyol containing reactant to produce a urethane resin, and are preferably separately packaged in piston and cylinder dual cartridges of the there illustrated, well-known dispenser. The two reagent Sides A and B are expressed from their respective cartridges with hand pressure on a piston pair and upon such expression are intensively mixed in cartridge-attached static mix tip and injected into recess 12.

A typical resin formulation (parts by weight per 100 parts) includes:

| | Parts (Wt.) |
|---|---|
| Side A | |
| Methylene-bis-dicyclohexane diisocyanate (Desmodur W) | 23.4 |
| (Methylene bis-(4-cyclohexylisocyanate) | |
| Polyoxy propylene oxide ether polyol, triol (6000 MW) | 59.8 |
| (Multranol 3901) | |
| Isocyanatopropyltriethoxysilane (Silquest A1310) | 1.0 |
| Black pigment | 2.2 |
| Methylene-bis-diphenyl diisocyanate (Isonate 2143L) | 13.6 |
| (Methylenediphenyl diisocyanate) | |
| Total, Part A | 100 |
| Side B | |
| Multranol 3901 | 78.0 |
| (Polyoxy propylene oxide ether polyol, triol (6000 MW)) | |
| Diethylmethylbenzenediamine (DETDA) | 18.0 |
| Bismuth naphthenate (Coscat 83) | 4.0 |
| (Neodecanoic acid, bismuth (3+) salt) | |
| Total, Part B | 100 |

Properties of this formulation include:

| | | |
|---|---|---|
| Work time | 15-20 | seconds |
| Tack free time | <7 | minutes |
| Hardness | >65 | (Shore A) |

The resultant urethane resin plug mass 28 is solid and being free of foam-formers will be free of voids and pockets of air or gas when cured, unlike foam systems which deliberately create voids. The plug mass 28 cures in place, i.e. in situ. Viscosities of the fluid form of the plug 10 are selected such that the incorporation of the incipient plug into the recess 12 is quickly accomplished, in a matter of seconds. The resin plug 10 can be of any of the various known thermoplastic resins or thermosetting resins meeting the invention criteria of low viscosity upon introduction into the recess 12 such as by injection, and rapid gelling or cure to a substantially solid viscosity, e.g. 100,000 centipoises. A rapidly high viscosity gives the resin plug mass 28 the ability to not flow from the recess 12 although the hoof is not held with the recess 12 facing upward. This increased viscosity preferably happens in seconds such as 15-20 seconds or less, but other longer times, where conditions permit, and where the foregoing handling criteria are met can be used. Resin compositions are usefully packaged in dual cartridge packages from which they may be discharged through a static mixer tip to combine into a reactive mixture which is injectable into the recess 12. For rapid cure to a sufficiently gelled state, the amount of catalyst should be selected in concert with desired cure time, e.g. 4% by weight of a urethane reaction catalyst for a <20 second cure to the adequately gelled state.

While resins, such as the preferred urethane resins herein may be initially tacky, this tackiness is quickly lost, typically in under 7 minutes. The preferred application method of incorporation by injection mentioned above makes tackiness or not unimportant since the resins can be injected directly and no hand or spatula contact is required, only a smoothing a plastic film is if further smoothness, e.g. of a particular contour is desired.

A useful resin herein is a urethane resin prepared from one or more isocyanates, catalysts, and various polyols, such as disclosed in U.S. Pat. Nos. 4,869,400; 6,009,952; 6,131,665 and 6,412,566, the disclosures of which are hereby incorporated herein in their entirety. Epoxies, polyesters, vinyl resins and other resins meeting the invention criteria can also be used. The term curing herein refers to polymerization, whether of the thermosetting or thermoplastic type, between resin components, or other processes including thixotropy by which a resin or resins change from a liquid to a solid state, including by loss of a diluent or solvent.

The invention accordingly provides products and methods for improving the health of hoofed animals particularly barefoot horses by combining the packing, pad and “shoe” into a single application that is simple enough for the nonprofessional skilled owner to practice, using a hoof recess-filling plug from reactive resin mixtures filled into the hoof recess from a dual cartridge dispenser containing separate, reactive precursor components of the hoof packing and plug-shoe-forming material that sets up quickly to a firm, somewhat resilient plug mass that adheres to and yet moves with the hoof wall, frog and sole portions as they move under the forces of ground impacts, plug adhesion militating against loss of the plug from the recess and plug deterioration even over weeks of use, and preventing incursions of environmental hazards such as trail debris and moisture between the plug and the hoof portions.

I claim:

1. An all-in-one packing, pad and shoe for barefoot horse hoof protection, comprising a plug of synthetic organic resin dimensioned for ground contact from within the hoof.

2. The all-in-one packing, pad and shoe for barefoot horses according to claim 1, in which said hoof is free of an external horseshoe.

3. The all-in-one packing, pad and shoe for horse hoof protection according to claim 1, in which said synthetic organic resin plug is formed in situ.

4. The all-in-one packing, pad and shoe for horse hoof protection according to claim 1, in which said synthetic organic resin is a urethane resin formed from reactive components jointly introduced within said hoof.

5. An all-in-one packing, pad and shoe for full barefoot horse hoof protection, comprising a plug of solid, void-free synthetic organic resin formed in situ and in adherent contact within the hoof against debris and moisture incursions and dimensioned for ground contact adjacent the hoof side wall face, said hoof being free of an external horse shoe.

6. The all-in-one packing, pad and shoe for horse hoof protection according to claim 5, in which said synthetic organic resin plug is formed in situ.

7. The all-in-one packing, pad and pad for horse hoof protection according to claim 6, in which said synthetic organic resin is formed from reactive components jointly introduced within said hoof.

8. The all-in-one packing, pad and shoe for horse hoof protection according to claim 7, in which said synthetic organic resin plug reactive components comprise urethane reactants reacting to a resin having a non-flowing condition in less than about 15-20 seconds and having a resistance to deterioration requiring replacement for at least about 15-20 days.

9. A method for extended protection of a shoe-less hoof having a hoof side wall and bottom wall forming an interior recess from environmental hazards with a synthetic organic resin plug, including cleaning said recess, and adding said resin plug into said recess in fixed relation and dimensioned sufficient for ground contact.

10. The method according to claim 9, including also maintaining said hoof external horse shoe free.

11. The method according to claim 9, including also using a plug comprised of urethane resin.

12. The method according to claim 9, including also smoothing the just added resin with a nonadherent wipe to a desired contour.

13. A method for extended protection of a shoe-less hoof having a hoof side wall and bottom wall forming an interior recess from environmental hazards with a resin plug, including cleaning said recess and adding to said recess to form a plug of resin in fixed relation and dimensioned sufficient for ground contact in the absence of a shoe a resin reactant mixture that flows freely into said recess while simultaneously reacting said mixture at a rate precluding spillage of said resin from said recess while leaving the hoof free of an external shoe.

14. The method according to claim 13, including also smoothing the exposed portion of said plug resin reaction mixture with a resin-nonadherent plastic film.

15. The combination of an external horseshoe-free horse hoof and a plug according to claim 1.

16. The combination of a shoeless horse hoof having a hoof side wall and a bottom wall forming an interior recess and a fixed resin plug in said recess according to the method of claim 9.

17. An all-in-one packing, pad and shoe for barefoot horse hoof protection, comprising a plug of resin in fixed relation with the hoof bottom wall and interior side wall sufficient for ground contact adjacent the hoof wall face, the hoof side wall face being free of an external horseshoe.

18. An all-in-one packing, pad and shoe for barefoot horse hoof protection, comprising a hoof interior-adherent plug of resin dimensioned for ground contact.

19. The all-in-one packing, pad and shoe for barefoot horses according to claim 18, in which said hoof is free of an external horseshoe.

20. The all-in-one packing, pad and shoe for horse hoof protection according to claim 18, in which said resin plug is formed in situ.

21. The all-in-one packing, pad and shoe for horse hoof protection according to claim 18, in which said resin is a urethane resin formed from reactive components jointly introduced into said hoof.

22. An all-in-one packing, pad and shoe for full barefoot horse hoof protection, comprising a plug of solid, void-free resin formed in situ and in adherent contact with the hoof interior against debris and moisture incursions and dimensioned for ground contact adjacent the hoof side wall face, said hoof being free of an external horse shoe.

23. The all-in-one packing, pad and shoe for horse hoof protection according to claim 22, in which said resin plug is formed in situ.

24. The all-in-one packing, pad and pad for horse hoof protection according to claim 23, in which said resin is formed from reactive components jointly introduced into said hoof.

25. The all-in-one packing, pad and shoe for horse hoof protection according to claim 24, in which said resin plug reactive components comprise urethane reactants reacting to a resin having a non-flowing condition in less than about 15-20 seconds and having a resistance to deterioration requiring replacement for at least about 15-20 days.

26. The all-in-one packing, pad and shoe for horse hoof protection according to claim 25, in which said resin plug reactive urethane components comprise reactants solidifying sufficiently rapidly as to flow into but not out of a horse hoof whose side wall face is held normal to the ground.

27. A method for extended protection of a shoe-less hoof having a hoof side wall and bottom wall forming an interior recess from environmental hazards with a resin plug, including cleaning said recess, and adherently adding said resin plug into said recess dimensioned sufficient for ground contact.

28. The method according to claim 27, including also maintaining said hoof external horse shoe free.

29. The method according to claim 27 including also using a plug comprised of urethane resin.

30. The method according to claim 27, including also smoothing the just added resin with a nonadherent wipe to a desired contour.

31. A method for extended protection of a shoe-less hoof having a hoof side wall and bottom wall forming an interior recess from environmental hazards with a resin plug, including cleaning said recess and adding to said recess to form a plug of resin dimensioned sufficient for ground contact in the absence of a shoe a resin reactant mixture that flows freely into said recess in adhering relation while simultaneously reacting said mixture at a rate precluding spillage of said resin from said recess while leaving the hoof side wall face free of resin and free of external shoe material.

32. The method according to claim 31, including disposing said hoof side wall face to receive said free flowing resin.

33. The method according to claim 32, including also smoothing the exposed portion of said plug resin reaction mixture with a resin-nonadherent plastic film.

34. The combination of an external horseshoe-free horse hoof and a plug according to claim 18.

35. The combination of a shoeless horse hoof having a hoof side wall and a bottom wall forming an interior recess and an adherent resin plug in said recess according to the method of claim 27.

36. An all-in-one packing, pad and shoe for barefoot horse hoof protection, comprising a plug of resin in adherent contact with the hoof bottom wall and a vertical extent of the interior hoof side wall sufficient for ground contact adjacent the hoof wall face, the hoof side wall face being free of an external horseshoe.

37. The all-in-one packing, pad and shoe for horse hoof protection according to claim 36, in which said resin plug is formed in situ.

38. The all-in-one packing, pad and shoe for horse hoof protection according to claim 36, in which said resin is a urethane resin formed from reactive components jointly introduced into said hoof.

39. An all-in-one packing, pad and shoe for full barefoot horse hoof protection, comprising a plug of solid, void-free resin formed in situ and in adherent contact with the hoof bottom wall and sufficient vertical extent of the interior hoof side wall to block debris and moisture incursions, said plug being sized for ground contact adjacent the hoof side wall face, said hoof being free of an external horse shoe.

40. The all-in-one packing, pad and shoe for horse hoof protection according to claim 39, in which said resin plug is formed in situ.

41. The all-in-one packing, pad and pad for horse hoof protection according to claim 40, in which said resin is formed from reactive components jointly introduced into said hoof.

42. The all-in-one packing, pad and shoe for horse hoof protection according to claim 41, in which said resin plug reactive components comprise urethane reactants reacting to a resin having a non-flowing condition in less than about 15-20 seconds and having a resistance to deterioration requiring replacement for at least about 15-20 days.

43. The all-in-one packing, pad and shoe for horse hoof protection according to claim 42, in which said resin plug reactive urethane components comprise reactants solidifying sufficiently rapidly as to flow into but not out of a horse hoof whose side wall face is held normal to the ground.

44. A method for extended protection of a shoe-less hoof having a hoof side wall and bottom wall forming an interior recess from environmental hazards with a resin plug, including cleaning said recess and adding said resin plug into the recess in fixed relation and dimensioned for ground contact.

45. The method according to claim 44, including also filling said recess to substantially the full vertical extent of the hoof side wall sufficient for ground contact with said resin plug and adhering said resin plug to said hoof bottom wall and hoof side wall and said extent of said hoof side wall and freely of an external shoe beyond said plug.

46. The method according to claim 45 including also using a plug comprised of urethane resin formed in situ.

47. The method according to claim 46, including also smoothing the just dispensed resin with a nonadherent wipe to a desired contour.

48. A method for extended protection of a shoe-less hoof having a hoof side wall and bottom wall forming an interior recess from environmental hazards with a resin plug, including cleaning said recess and filling said recess to substantially the full vertical extent of the hoof side wall sufficient for ground contact in the absence of a shoe with a resin reactant mixture that flows freely into said recess in adhering relation while simultaneously reacting said mixture at a rate precluding spillage of said resin from said recess while leaving the hoof side wall face free of resin.

49. The method according to claim 48, including also smoothing the exposed portion of said plug with a resin-nonadherent plastic film.

50. The combination of a horseshoe-free horse hoof and a plug according to claim 36.

51. The combination of a shoeless horse hoof having a hoof side wall and a bottom wall forming an interior recess and a resin plug filling said recess according to the method of claim 44.
